(19) United States
(12) Patent Application Publication
(10) Pub. No.: US 2006/0220793 A1
(43) Pub. Date: Oct. 5, 2006

(54) Mobile radio frequency identification reader, portable terminal having the same, and FR transmission power setting method thereof

(75) Inventors: Kyung-ho Park, Suwon-si (KR); Woo-shik Kang, Suwon-si (KR); Jin-young Yang, Seoul (KR); Hyung-min Yoon, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD., Suwon-si (KR)

(21) Appl. No.: 11/391,393

(22) Filed: Mar. 29, 2006

(30) Foreign Application Priority Data
Mar. 30, 2005 (KR) 10-2005-0026651
Dec. 21, 2005 (KR) 10-2005-0127208

(51) Int. Cl. H04Q 5/22

(52) U.S. Cl. 340/10.3; 340/572.1

(57) ABSTRACT

A mobile radio frequency identification (RFID) reader, a portable terminal having the same, and an RF transmission (Tx) power setting method thereof. The RF Tx power setting method includes selecting an RF Tx power of an RF Tx power which is used to read tag information from an RF identification (RFID) tag; and setting the selected RF Tx power to a Tx power of the RF Tx signal. Accordingly, since it is possible to variably set the Tx power of the RF Tx signal used to read out the tag information from the RFID tag, the power consumption can be reduced at the RFID reader or the portable terminal equipped with the RFID reader.

### CROSS-REFERENCE TO RELATED APPLICATIONS

This application claims priority under 35 U.S.C. § 119 (a) from Korean Patent Application No. 10-2005-0026651 filed on Mar. 30, 2005 and Korean Patent Application No. 10-2005-0127208 filed on Dec. 21, 2005, in the Korean Intellectual Property Office, the entire disclosures of which are incorporated herein by reference.

### BACKGROUND OF THE INVENTION

1. Field of the Invention

Apparatuses and methods consistent with the present invention relate to a mobile radio frequency identification (RFID) reader, a portable terminal having the mobile RFID reader, and an RF transmission (Tx) power setting method thereof, and more particularly to a mobile RFID reader for variably setting a Tx power of an RF Tx signal which is used to read out tag information contained in an RFID tag, a portable terminal applying the mobile RFID reader, and an RF Tx power setting method.

2. Description of the Related Art

The RFID technology has been developed to keep up with the changes in production methods, the changes in consumption patterns, and the advance of culture and technology, and to overcome disadvantages of a barcode and a magnetic card.

The RFID, which is part of automated identification and data capture (AIDC), reads out data stored in a tag having a microchip therein via RF without physical contact.

An RFID tag is attached to various movable objects and capable of tracking and identifying easily the location of the objects which are movable. That is, the RFID tag is attached to objects, animals, persons, etc., to thus automatically identify and track them using an RFID reader.

A barcode system of the related art requires a passive scanning operation. In contrast, the RFID system can automatically identify the object by means of the information aforementioned.

As discussed above, since the RFID system can automatically identify objects and track their locations, its diverse applications include material distributions such as library and large-scale retailer, and rental business such as music record, books, and DVDs. The RFID system is far more advantageous in terms of the efficient product management in comparison with the barcode system of the related art.

The recent concerns about the RFID system are how to reduce power consumption of the RFID reader, how to prevent interference between RFID readers when a plurality of RFID reader nearby read out one or plural RFID tags in the massed area, and how to provide a user with the convenience when manipulating the RFID reader. Therefore, a demand arises for an efficient solution to respond to these concerns.

### SUMMARY OF THE INVENTION

The present invention provides a mobile RFID reader for variably setting a Tx power of an RF Tx signal used to read out tag information from an RFID tag so as to prevent a user from experiencing cumbersomeness due to too many RFID tags read out, to avoid interference between RFID readers, to facilitate the user's manipulation, and to reduce the power consumption required to read out tag information from the RFID tag, a portable terminal applying the mobile RFID reader and an RF Tx power setting method thereof.

In accordance with the aspect of the present invention, an RF Tx power setting method comprises selecting an RF Tx power of an RF Tx power which is used to read tag information from an RF identification (RFID) tag; and setting the selected RF Tx power to a Tx power of the RF Tx signal.

The RF Tx power may comprise a percentage of a maximum Tx power of a generatable RF Tx signal.

The RF Tx power setting method may further comprise transmitting the RF Tx signal with the set RF Tx power and determining whether the tag information is successfully read from the RFID tag.

The RF Tx power setting method may further comprise selecting another RF Tx power different from the selected RF Tx power if it is determined that the tag information is not successfully read from the RFID tag; and setting the other RF Tx power to the Tx power of the RF Tx signal.

The other RF Tx power may be greater than the selected RF Tx power.

The RF Tx power setting method may further comprise receiving information relating to the RF tx power which is input using at least one of a menu screen and a short key, wherein the RF Tx power of the RF Tx signal which is used to read the tag information from the RFID tag, is selected based on the received information.

The information relating to the RF Tx power input at the receiving operation may comprise information relating to at least one of a percentage of a maximum Tx power of the RF Tx signal and a range of the RF Tx signal.

The RF Tx power may be automatically selected using an application which is created to automatically select the RF Tx power.

The RF Tx power automatically selected may be one of an RF Tx power of a latest selection, an RF Tx power which was most frequently selected, an average value of RF Tx powers that have been selected, a mid-value of a maximum Tx power, the maximum Tx power, a minimum Tx power, and a Tx power within a range of selectable RF Tx powers.

The RF Tx power setting method may further comprise checking a channel status, wherein the RF Tx power is selected based on a result of the checking of the channel status.

The RF Tx power may be selected according to a control signal received from an external device.

In accordance with another aspect of the present invention, an RF Tx power setting method comprises selecting one of generatable RF Tx signals; and setting the selected RF Tx signal to an RF Tx signal which is used to read tag information from an RFID tag.

In accordance with another aspect of the present invention, a portable terminal comprises an RFID reader which reads tag information from an RFID tag by transmitting an RF Tx signal; and a portable terminal control block which selects an RF Tx power of an RF Tx signal which is used to read the tag information from the RFID tag, wherein the RFID reader comprises an RFID reader controller which sets the selected RF Tx power to a Tx power of the RF Tx signal.

The RF Tx power may comprise a percentage of a maximum Tx power of the generatable RF Tx signals.

The RFID reader controller may determine whether the tag information is successfully read from the RFID tag by transmitting the RF Tx signal with the set RF Tx power.

The portable terminal control block may select another RF Tx power different from the selected RF Tx power if it is determined that the tag information is not successfully read from the RFID tag, and the RFID reader controller may set the other RF Tx power to the Tx power of the RF Tx signal.

The other RF Tx power may be greater than the selected RF Tx power.

The portable terminal control block may receive information relating to the RF Tx power which is input using at least one of a menu screen and a short key, and selects the RF Tx power of the RF Tx signal which is used to read the tag information from the RFID tag, based on the received information.

The input information relating to the RF Tx power may comprise information relating to at least one of a percentage of a maximum Tx power of the RF Tx signal and a range of the RF Tx signal.

The portable terminal control block may automatically select the RF Tx power using an application which is created to automatically select the RF Tx power.

The portable terminal control block automatically selects, as an RF Tx power, one of an RF Tx power of a latest selection, an RF Tx power which was most frequently selected, an average value of RF Tx powers that have been selected, a mid-value of a maximum Tx power, the maximum Tx power, a minimum Tx power, and a Tx power within a range of selectable RF Tx powers.

The portable terminal control block may select the RF Tx power based on a channel status.

The portable terminal control block may select the RF Tx power according to a control signal received from an external device.

In accordance with another aspect of the present invention, a portable terminal comprises an RFID reader, which reads tag information from an RFID tag by transmitting an RF Tx signal; and a portable terminal control block which selects one of generatable RF Tx signals, wherein the RFID reader comprises an RFID reader controller which sets the selected RF Tx signal to an RF Tx signal which is used to read the tag information from the RFID tag.

In accordance with another aspect of the present invention, a portable terminal comprises an RFID reader, which reads tag information from an RFID tag by transmitting an RF Tx signal; and a portable terminal control block which selects an RF Tx power of an RF Tx signal which is used to read the tag information from the RFID tag, and sets the selected RF Tx power to a Tx power of the RF Tx signal.

In accordance with another aspect of the present invention, an RFID reader, which reads tag information from an RFID tag by transmitting an RF Tx signal, comprises an RFID reader controller which sets an RF Tx power of the RF Tx signal to a Tx power, wherein the RF Tx signal is selected by an external device and used to read the tag information from the RFID tag.

In accordance with another aspect of the present invention, an RFID reader reads tag information from an RFID tag by transmitting an RF Tx signal. The RFID reader sets an RF Tx power of the RF Tx signal to a Tx power of the RF Tx signal, wherein the RF Tx signal is selected by an external device and used to read the tag information from the RFID tag.

### BRIEF DESCRIPTION OF THE DRAWING FIGURES

These and/or other aspects of the present invention will become more apparent and more readily appreciated from the following description of exemplary embodiments thereof, with reference to the accompanying drawings, in which:

FIG. 1 is an exemplary diagram illustrating a mobile RFID system to which the present invention is applicable;

FIG. 2 is a block diagram of a portable terminal equipped with the mobile RFID reader according to an exemplary embodiment of the present invention;

FIG. 3 is an exemplary flowchart outlining an RF Tx power setting method of the portable terminal of FIG. 2;

FIG. 4 is an exemplary diagram illustrating an RF Tx power selection menu screen;

FIG. 5 is a block diagram of a portable terminal equipped with a mobile RFID reader according to another exemplary embodiment of the present invention;

FIG. 6 is an exemplary flowchart outlining an RF Tx power setting method of the portable terminal of FIG. 5; and

FIG. 7 is an exemplary diagram of another RF Tx power selection menu screen.

### DETAILED DESCRIPTION OF THE EXEMPLARY EMBODIMENTS

Certain exemplary embodiments of the present invention will now be described in greater detail with reference to the accompanying drawings.

In the following description, the same drawing reference numerals are used to refer to the same elements, even in different drawings. The matters defined in the following description, such as detailed construction and element descriptions, are provided as examples to assist in a comprehensive understanding of the invention. Also, well-known functions or constructions are not described in detail, since they would obscure the invention in unnecessary detail.

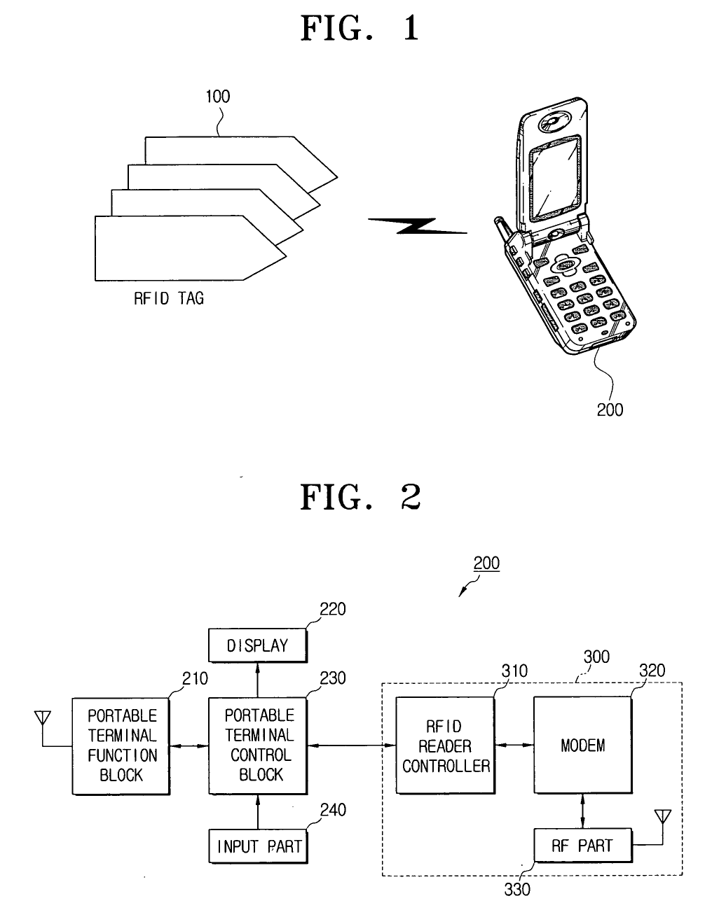

FIG. 1 depicts a mobile RFID system to which the present invention is applicable. As shown in FIG. 1, the mobile RFID system includes at least one RFID tag 100 and a portable terminal 200 which identifies the RFID tag 100.

The portable terminal 200 may be a mobile phone, a personal digital assistant (PDA) and the like, which a user can carry along. The portable terminal 200 is capable of providing text and/or graphical information to the user by means of a display. According to an exemplary embodiment of the present invention, the portable terminal 200 is equipped with a mobile RFID reader that can read out tag information from the RFID tag 100.

The RFID tag 100 of the RFID system is attachable to a stationary object, and the portable terminal 200 is movable while being carried along with the user. Under this RFID system environment, it is supposed that the user carrying the portable terminal 200 do the shopping in a mart where products the RFID tag 100 is respectively attached are arranged. The present invention is also applicable to an environment where the RFID tag 100 is stationary and the mobile RFID reader equipped to the portable terminal 200 is movable.

Although FIG. 1 illustrates only one portable terminal 200 in the RFID system by way of example, the RFID system may include a plurality of portable terminals.

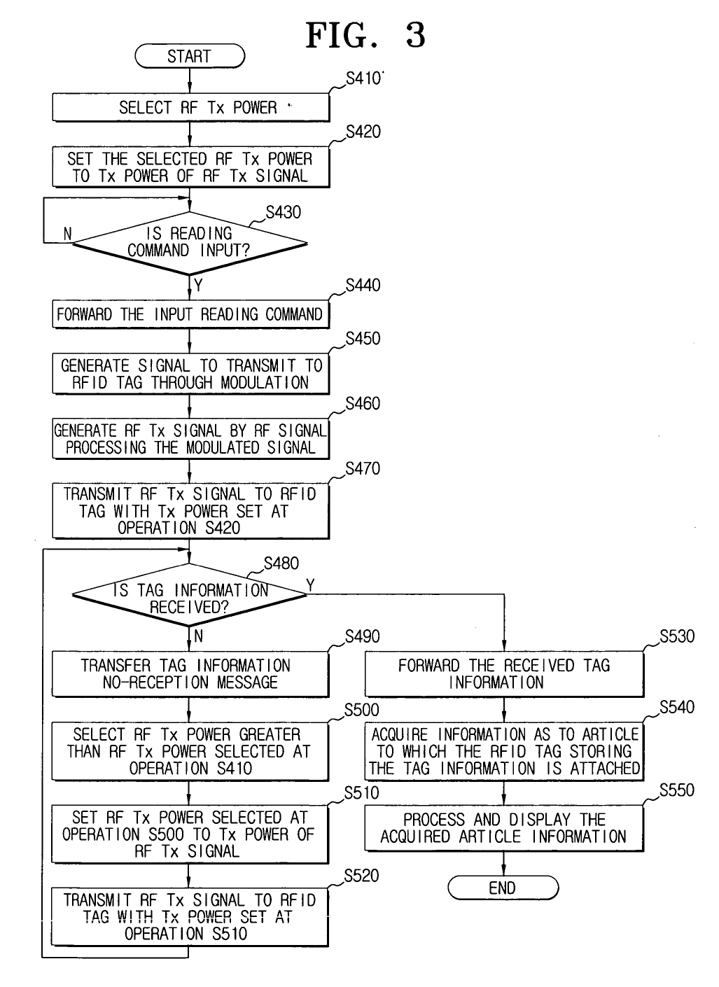

In the following, the portable terminal 200 equipped with the RFID reader of FIG. 1 is explained in further detail in reference to FIG. 2. FIG. 2 is a block diagram of the portable terminal provided with the mobile RFID reader according to an exemplary embodiment of the present invention.

Referring to FIG. 2, the portable terminal 200 includes a portable terminal function block 210, a display 220, a portable terminal control block 230, and an input part 240. The portable terminal 200 is equipped with an RFID reader 300.

The portable terminal function block 210 performs basic functions of the portable terminal 200, such as telephone communication, data communication and additional functions.

The display 220 displays an operation state of the portable terminal 200 or graphical user interface (GUI) such as menu screen, to the user under the control of the portable terminal control block 230.

The portable terminal control block 230 controls the portable terminal function block 210 and displays on the display 220 information and the GUI corresponding to a manipulation command of the user that is input through the input part 240.

The RFID reader 300 reads out tag information stored in the RFID tag 100. As shown in FIG. 2, the RFID reader 300 includes an RFID reader controller 310, a modem 320, and an RF part 330.

The modem 320 is responsible to generate a signal to transmit to the RFID tag 100 using the modulation. The RF part 330 generates an RF Tx signal by performing an RF signal processing with respect to the modulated signal output from the modem 320 and then transmits the RF Tx signal to the RFID tag 100 via an antenna.

In addition, the RF part 330 converts the tag information received from the RFID tag 100 to a baseband signal. The modem 320 demodulates the tag information output from the RF part 330. The demodulated tag information is forwarded to the portable terminal control block 230 through the RFID reader controller 310.

The RFID reader controller 310 controls operations of the modem 320 and the RF part 330 according to a control command input via the portable terminal control block 230.

Hereafter, descriptions are explained as to how to set a Tx power of the RF Tx signal which is used for the portable terminal 200 to read out the tag information from the RFID tag 100 of FIG. 2, in reference to FIG. 3. FIG. 3 is a flowchart outlining the RF Tx power setting method of the portable terminal 200 of FIG. 2.

Referring now to FIG. 3, the portable terminal control block 230 selects a Tx power of the RF Tx power which is used to read out the tag information from the RFID tag 100 (hereafter, referred to as an “RF Tx power”) (S410).

Specifically, the portable terminal control block 230 selects a ratio or percentage of a maximum Tx power of a generatable RF Tx signal (hereafter, referred to as an “RF Tx power ratio or percentage”) (S410).

For instance, the portable terminal control block 230 can set the RF Tx power percentage to 1) 100% of a maximum Tx power, 2) 80% of a maximum Tx power, 3) 60% of a maximum Tx power, or 4) 40% of a maximum Tx power.

In doing so, the portable terminal control block 230 may select the RF Tx power ratio based on the user's input on an RF Tx power selection menu screen, or using an application created to automatically select the RF Tx power ratio.

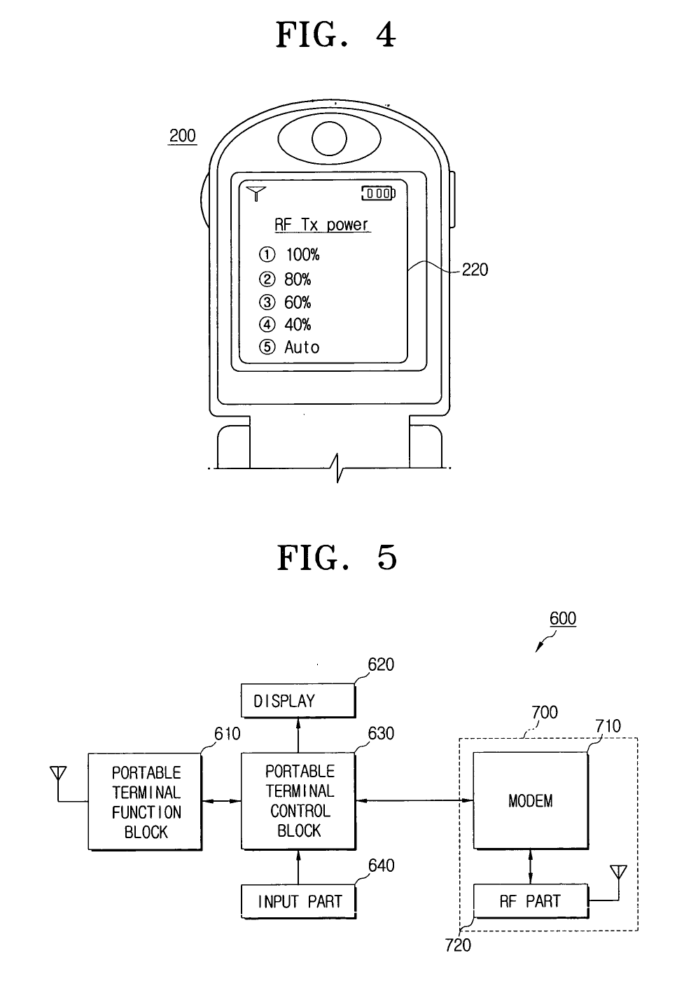

FIG. 4 partially depicts the portable terminal 200 that displays the RF Tx power selection menu screen on the display 220.

Referring to FIG. 4, the RF Tx power selection menu screen displays menu items of “100%,” “80%,” “60%,” “40%,” and “Auto.” The user can select one of the displayed menu items by use of keys provided to the input part 240.

In the event that the user selects the menu item “80%,” the portable terminal control block 230 sets the RF Tx power percentage to “80%” of the maximum Tx power. In event that the user selects the menu item “Auto,” the portable terminal control block 230 automatically sets the RF Tx power ratio by using the application created to automatically select the RF Tx power ratio.

The ratio automatically selected may be one of the mid-value (50%) of a maximum Tx power, an RF Tx power ratio of a latest selection, an RF Tx power ratio which was most frequently selected, and an average value of RF Tx power ratios that have been selected, the maximum Tx power, the minimum Tx power, and a Tx power within a range of selectable RF Tx powers.

In event that the user selects the menu item “Auto,” the portable terminal control block 230 may check the channel status using the portable terminal function block 210 and then select the RF Tx power ratio based on the checked channel status.

It is apparent that the user may input the RF Tx power ratio using a short key provided to the input part 240, rather than using the menu screen.

Referring back to FIG. 3, after operation S410, the RFID reader controller 310 sets the RF Tx power which is selected by the portable terminal control block 230, to a Tx power of an RF Tx signal used to read out the tag information from the RFID tag 100 (hereafter, referred to as an “RF Tx signal”) (S420).

More specifically, the RFID reader controller 310 sets the Tx power of the RF Tx signal by storing the RF Tx power which is selected by the portable terminal control block 230 at operation S410, in one of a register in the RFID reader controller 310, a register in the modem 320, and a register in the RF part 330.

Next, the portable terminal control block 230 determines whether the user inputs a command instructing to read the RFID tag 100 (hereafter, referred to as a “reading command”) (S430).

The reading command can be input by the user using the menu screen or the short key provided to the input part 240, similar to the input of the RF Tx power.

When the input of the reading command is determined (S430-Y), the portable terminal control block 230 forwards the input reading command to the RFID reader controller 310 (S440).

Upon receiving the reading command, the RFID reader controller 310 controls the modem 320 to generate a signal to transmit to the RFID tag 100 through the modulation (S450).

The RFID reader controller 310 controls the RF part 330 to generate the RF Tx signal by performing the RF signal processing with respect to the modulated signal output from the modem 320 (S460).

The RF part 330 transmits the RF Tx signal to the RF ID tag 100 with the Tx power set by the RFID reader controller 310 (S470).

Next, the RFID reader controller 310 determines, using the RF part 330 and the modem 320, whether the tag information is received from the RFID tag 100 (S480).

It can be understood that operation S480 determines whether the tag information is read out from the RFID tag 100 using the RF Tx signal which was transmitted with the Tx power set by the RFID reader controller 310.

When the tag information is not received, that is, when the reading of the tag information is failed (S480-N), the RFID reader controller 310 transfers a tag information no-reception message to the portable terminal control block 230 (S490).

Upon receiving the tag information no-reception message (S490), the portable terminal control block 230 selects another RF Tx power greater than the RF Tx power selected at operation S410 (S500).

The RFID reader controller 310 sets the Tx power of the RF Tx signal to the RF Tx power which is selected by the portable terminal control block 230 at operation S500 (S510).

Accordingly, the RF part 330 transmits the RF Tx signal to the RFID tag 100 with the Tx power which is set by the RFID reader controller 310 at operation S510 (S520). Afterwards, operations from operation S480 are carried out again.

Meanwhile, when the tag information is received, that is, when the reading of the tag information is successful (S480-Y), the RFID reader controller 310 forwards the received tag information to the portable terminal control block 230 (S530).

Next, the portable terminal control block 230 provides the tag information to an external server (not shown) via the portable terminal function block 210 and thus acquires information relating to the article to which the RFID tag 100 storing the tag information is attached, from the external server (S540).

The portable terminal control block 230 processes to display the acquired information on the display 220 so that the user can refer the information (S550).

According to an exemplary embodiment of the present invention, the Tx power of the RF Tx signal is set to the RF Tx power selected by the portable terminal control block 230 by storing the selected RF Tx power to one of the register of the RFID reader controller 310, the register of the modem 320, and the register of the RF part 330.

It will be sure understood that the RF Tx power selected by the portable terminal control block 230 may be stored in either the register of the portable terminal control block 230 or a memory (not shown) of a portable terminal 200.

In this case, it is preferred, but not necessary, that the portable terminal control block 230 provides the RFID reader controller 310 with the stored RF Tx power together with the input reading command at operation S440.

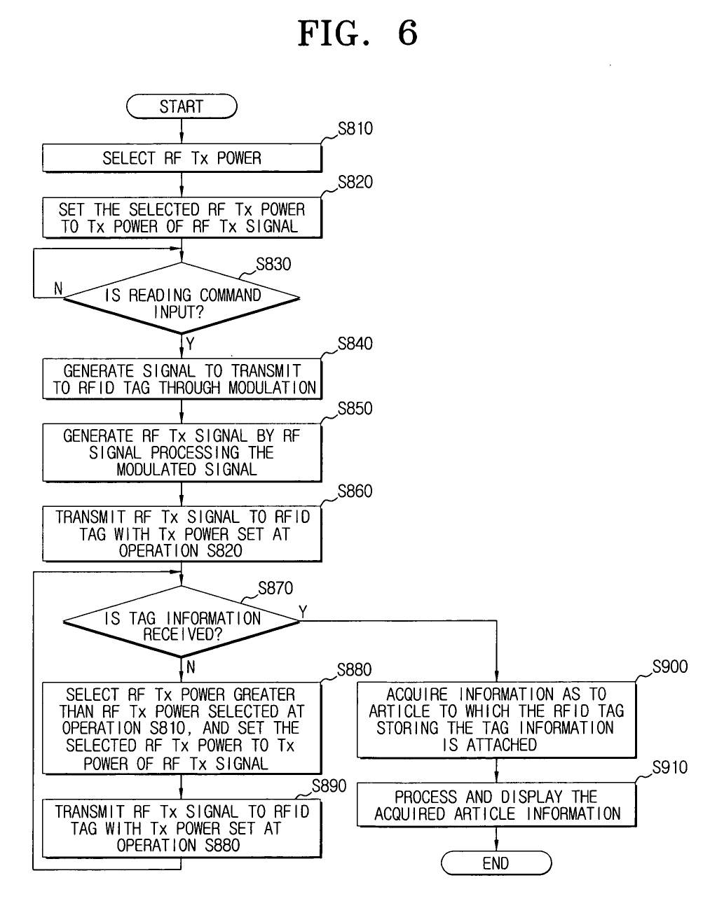

Hereafter, another exemplary embodiment of the present invention is now described in reference to FIGS. 5 and 6. FIG. 5 is a block diagram of a portable terminal equipped with a mobile RFID reader according to another exemplary embodiment of the present invention.

In FIG. 5, the RFID reader 700 of the portable terminal 600, unlike the portable terminal 200 of FIG. 2, is not equipped with the RFID reader controller 310. A portable terminal control block 630 of the portable terminal 600 also serves as the RFID reader controller 310 being omitted. In detail, the portable terminal control block 630 controls the operations of a modem 710 and an RF part 720 that are provided to an RFID reader 700.

Detailed descriptions on a portable terminal function block 610, a display 620, the portable terminal control block 630, an input part 640, the modem 710 and the RF part 720 of the RFID reader 700 as shown in FIG. 5 will be omitted for conciseness because their functions are similar to the portable terminal function block 210, the display 220, the portable terminal control block 230, the input part 240, the modem 320 and the RF part 330 of the RFID reader 300 as shown in FIG. 2.

In the following, descriptions are made on a method of setting a Tx power of an RF Tx signal which is used for the portable terminal 600 of FIG. 5 to read tag information from the RFID tag 100, in reference to FIG. 6. FIG. 6 is an exemplary flowchart outlining an RF Tx power setting method of the portable terminal 600 of FIG. 5.

First, the portable terminal control block 630 selects an RF Tx power (S810). As aforementioned in one exemplary embodiment of the present invention, the portable terminal control block 630 may select an RF Tx power ratio.

The portable terminal control block 630 sets the RF Tx power selected at operation S810 to a Tx power of the RF Tx signal (S 820).

In more detail, to set the Tx power of the RF Tx signal, the portable terminal control block 630 stores the RF Tx power selected at operation S810 in either a register of the modem 710 or a register of the RF part 720.

Next, the portable terminal control block 630 determines whether a reading command is input from the user (S830).

When the reading command is input (S830-Y), the portable terminal control block 630 controls the modem 710 to generate a signal to transmit to the RFID tag 100 through the modulation (S840).

The portable terminal control block 630 also controls the RF part 720 to generate the RF Tx signal by performing the RF signal processing with respect to the modulated signal output from the modem 710 (S850).

The RF part 730 transmits the RF Tx signal to the RFID tag 100 with the Tx power set by the portable terminal control block 630 at operation S820 (S860).

Next, the portable terminal control block 630 determines whether tag information is received from the RFID tag 100, using the RF part 720 and the modem 710 (S870).

When the tag information is not received, that is, when the reading of the tag information is failed (S870-N), the portable terminal control block 630 selects another RF Tx power greater than the RF Tx power selected at operation S810 and sets the another RF Tx power to the Tx power of the RF Tx signal (S880).

Hence, the RF part 730 transmits the RF Tx signal to the RFID tag 100 with the Tx power set by the portable terminal control block 630 at operation S880 (S890). Subsequently, operations from operation S870 are carried out again.

By contrast, when the tag information is received, that is, when the reading of the tag information is successful (S870-Y), the portable terminal control block 630 forwards the received tag information to an external server (not shown) through the portable terminal function block 610 and then acquires from the external server information as to the article to which the RFID tag 100 storing the tag information is attached (S900).

The portable terminal control block 630 processes to display the acquired information on the display 620 so that the user can refer the information (S910).

In the above exemplary embodiment of the present invention, the Tx power of the RF Tx signal is set to the RF Tx power selected by the portable terminal control block 630 by storing the selected RF Tx power to either the register of the modem 710 or the register of the RF part 720.

It is to be understood that the RF Tx power selected by the portable terminal control block 630 may be stored in either the register of the portable terminal control block 630 or a memory (not shown) of a portable terminal 600. In doing so, it is advantageous that the portable terminal control block 630 provides the stored information relating to the RF Tx power to the modem 710 when the RFID reader 700 needs to operate.

It has been described that the RF Tx power is the RF Tx power ratio (i.e., the ratio of the generatable RF Tx signal to the maximum Tx power), and accordingly, it has been assumed that the user can input the RF Tx power ratio using the RF Tx power selection menu screen.

The RF Tx power ratio is selected as the RF Tx power for the sake of the user's convenience when inputting the RF Tx power. It is much easier for the user to recognize the RF Tx power ratio rather than a specific value indicative of the RF Tx power magnitude. In other words, the RF Tx power ratio rather than the RF Tx power magnitude is far more perceivable by the user.

Since the extent of the RF Tx power magnitude output from the RFID reader differs depending on its manufacturers, errors may arise when the user inputs the RF Tx power magnitude exceeding the extent. However, when the user inputs the RF Tx power ratio, there arise no such errors.

It is advantageous that the portable terminal control blocks 230 and 630 which control the RFID readers 300 and 700 should select the RF Tx power ratio rather than the RF Tx power magnitude. As described earlier, because the extent of the RF Tx power magnitude output from the RFID readers 300 and 700 varies according to the manufacturers, it is inefficient for the portable terminal control blocks 230 and 630 to store all the power extents of the manufacturers.

It should be understood that the user can input the RF Tx power using other parameters than the RF Tx power ratio.

For example, an available parameter is a range of the RF Tx signal. In this case, when the user inputs the range of the RF Tx signal using the RF Tx power selection menu screen or the input part 240 or 640, the portable terminal control block 230 or 630 calculates the corresponding RF Tx power ratio and selects the calculated RF Tx power ratio.

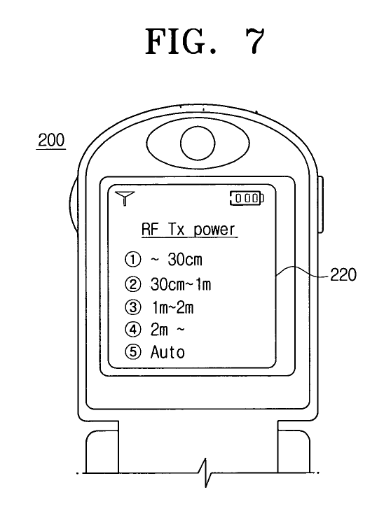

FIG. 7 partially depicts the portable terminal 200 which displays the menu screen for selecting the range of the RF Tx signal on the display 220.

As shown in FIG. 7, the menu screen displays menu items of “˜30 cm,” “30 cm˜1 m,” “1 m˜2 m,” “2 m˜,” and “Auto.” The user can select one of the displayed menu items using keys provided to the input part 240 or 640.

In event that the user selects the menu item “30 cm˜1 m,” the portable terminal control block 230 or 630 calculates an RF Tx power ratio enough to read the RFID tag 100 and selects the calculated RF Tx power ratio.

In the environment where the RFID tag 100 is stationary and the RFID reader equipped to the portable terminal 200 is movable, the variation of the RF Tx power implies the restriction of the number of readable RFID tags.

When a large number of RFID tags are distributed densely and the portable terminal 200 or 600 needs to read the numerous RFID tags, the RF Tx power can be lowered to prevent the display 220 or 620 from displaying a great deal of article information on the small screen. This situation may occur when the RFID reader is stationary and the RFID tag is carried along by the user.

By lowering the RF Tx power, the portable terminal 200 or 600 reads a small number of RFID tags and then displays less article information on the display 220 or 620.

In the above exemplary embodiments of the present invention, the portable terminal control block 230 or 630 selects the RF Tx power according to the user's input by means of the menu screen or the short key, or automatically selects the RF Tx power using the application.

Although it has been exemplified that the portable terminals 200 and 600 select the RF Tx power for themselves, the RF Tx power may be selected in other various methods. That is, the portable terminals 200 and 600 can select the RF Tx power according to a control signal received from an external device.

For example, upon receiving a control signal which contains a message instructing to restrict the RF Tx power percentage to 20%, from the external device which is located in an area where it is necessary to restrict the RF Tx power percentage to below a specific percentage because of frequent interferences between the RFID readers, e.g., in an crowded area such as libraries, the portable terminal 200 and 600 may set the RF Tx power to 20%.

In the exemplary embodiments as explained above, when the readout of the tag information is failed, the portable terminal control blocks 230 and 630 automatically select the greater RF Tx power. Alternatively, the portable terminal control blocks 230 and 630 display a message indicative of the failed readout of the tag information on the displays 220 and 620 to thus inform the user of the reading failure, and provide the RF Tx power selection menu screen to the displays 220 and 620 to thus allow the user to input his/her desired RF Tx power.

Although the above embodiments illustrate that the user inputs the RF Tx power and the reading command, separately, the input of the RF Tx power may include the input of the reading command.

Although the above exemplary embodiments illustrate that the portable terminal function blocks 210 and 610, and the RFID readers 300 and 700 are provided with an antenna, separately, a single antenna may be provided.

It is noted that the technical features of the present invention are also applicable when only the RFID readers 300 and 700 are implemented aside from the portable terminals 200 and 600.

It can be said that one of the generatable RF Tx signals are selected as the RF Tx signal in the above exemplary embodiments.

As set forth above, it is possible to variably set the Tx power of the RF Tx signal that is used to read out the tag information from the RFID tag. Therefore, the inconvenience due to too many read RFID tags can be prevented in advance.

In the area where the RFID readers are densely distributed, the Tx power of the RF Tx power can be lowered to avoid the interference between the plurality of adjacent RFID readers.

Additionally, the power consumption can be reduced at the RFID reader or the portable terminal equipped with the RFID reader.

The ratio or percentage in relation to the maximum Tx power is input as the Tx power of the RF Tx signal so that the user can easily perceive the RF Tx power. As a result, it is possible to facilitate the user's input and to prevent error due to the mistaken manipulation.

Furthermore, since the ratio or percentage to the maximum Tx power is utilized when selecting and setting the Tx power of the RF Tx signal, the design and the operation of the control block can be far more effectively realized.

Although a few exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A radio frequency (RF) transmission (Tx) power setting method comprising:
selecting an RF Tx power of an RF Tx signal which is used to read tag information from an RF identification (RFID) tag; and
setting the selected RF Tx power to a Tx power of the RF Tx signal.

2. The RF Tx power setting method of claim 1, wherein the RF Tx power comprises a percentage of a maximum Tx power of a generatable RF Tx signal.

3. The RF Tx power setting method of claim 1, further comprising transmitting the RF Tx signal with the set RF Tx power and determining whether the tag information is successfully read from the RFID tag.

4. The RF Tx power setting method of claim 3, further comprising:
selecting another RF Tx power different from the selected RF Tx power if it is determined that the tag information is not successfully read from the RFID tag; and
setting the other RF Tx power to the Tx power of the RF Tx signal.

5. The RF Tx power setting method of claim 4, wherein the other RF Tx power is greater than the selected RF Tx power.

6. The RF Tx power setting method of claim 1, further comprising receiving information relating to the RF Tx power which is input using at least one of a menu screen and a short key,
wherein, in the selecting, the RF Tx power of the RF Tx signal, which is used to read the tag information from the RFID tag, is selected based on the received information.

7. The RF Tx power setting method of claim 6, wherein the information relating to the RF Tx power input at the receiving operation comprises information relating to at least one of a percentage of a maximum Tx power of the RF Tx signal and a range of the RF Tx signal.

8. The RF Tx power setting method of claim 1, wherein, in the selecting, the RF Tx power is automatically selected using an application which is created to automatically select the RF Tx power.

9. The RF Tx power setting method of claim 8, wherein the RF Tx power automatically selected comprises one of an RF Tx power of a latest selection, an RF Tx power which was most frequently selected, an average value of RF Tx powers that have been selected, a mid-value of a maximum Tx power, the maximum Tx power, a minimum Tx power, and a Tx power within a range of selectable RF Tx powers.

10. The RF Tx power setting method of claim 1, further comprising checking a channel status, wherein the RF Tx power is selected based on a result of the checking of the channel status.

11. The RF Tx power setting method of claim 1, wherein, in the selecting, the RF Tx power is selected according to a control signal received from an external device.

12. An RF Tx power setting method comprising:
selecting one of generatable RF Tx signals; and
setting the selected RF Tx signal to an RF Tx signal which is used to read tag information from an RFID tag.

13. A portable terminal comprising:
a radio frequency identification (RFID) reader which reads tag information from an RFID tag by transmitting an RF transmission (Tx) signal; and
a portable terminal control block which selects an RF Tx power of an RF Tx signal which is used to read the tag information from the RFID tag,
wherein the RFID reader comprises an RFID reader controller which sets the selected RF Tx power to a Tx power of the RF Tx signal.

14. The portable terminal of claim 13, wherein the RF Tx power comprises a percentage of a maximum Tx power of the generatable RF Tx signals.

15. The portable terminal of claim 13, wherein the RFID reader controller determines whether the tag information is successfully read from the RFID tag by transmitting the RF Tx signal with the set RF Tx power.

16. The portable terminal of claim 15, wherein:
the portable terminal control block selects another RF Tx power different from the selected RF Tx power if it is determined that the tag information is not successfully read from the RFID tag; and
the RFID reader controller sets the other RF Tx power to the Tx power of the RF Tx signal.

17. The portable terminal of claim 16, wherein the other RF Tx power is greater than the selected RF Tx power.

18. The portable terminal of claim 13, wherein the portable terminal control block receives information relating to the RF Tx power, wherein the information is input using at least one of a menu screen and a short key, and selects the RF Tx power of the RF Tx signal which is used to read the tag information from the RFID tag, based on the received information.

19. The portable terminal of claim 18, wherein the input information relating to the RF Tx power comprises information relating to at least one of a percentage of a maximum Tx power of the RF Tx signal and a range of the RF Tx signal.

20. The portable terminal of claim 13, wherein the portable terminal control block automatically selects the RF Tx power using an application which is created to automatically select the RF Tx power.

21. The portable terminal of claim 20, wherein the portable terminal control block automatically selects, as the RF Tx power, one of an RF Tx power of a latest selection, an RF Tx power which was most frequently selected, an average value of RF Tx powers that have been selected, a mid-value of a maximum Tx power, the maximum Tx power, a minimum Tx power, and a Tx power within a range of selectable RF Tx powers.

22. The portable terminal of claim 13, wherein the portable terminal control block selects the RF Tx power based on a channel status.

23. The portable terminal of claim 13, wherein the portable terminal control block selects the RF Tx power according to a control signal received from an external device.

24. A portable terminal comprising:
a radio frequency identification (RFID) reader which reads tag information from an RFID tag by transmitting an RF transmission (Tx) signal, the portable terminal comprising; and
a portable terminal control block which selects one of generatable RF Tx signals,
wherein the RFID reader comprises an RFID reader controller which, as a component of the RFID reader, sets the selected RF Tx signal to an RF Tx signal which is used to read the tag information from the RFID tag.

25. A portable terminal comprising:
a radio frequency identification (RFID) reader which reads tag information from an RFID tag by transmitting an RF transmission (Tx) signal, the portable terminal; and
a portable terminal control block which selects an RF Tx power of an RF Tx signal which is used to read the tag information from the RFID tag, and sets the selected RF Tx power to a Tx power of the RF Tx signal.

26. A radio frequency identification (RFID) reader which reads tag information from an RFID tag by transmitting an RF transmission (Tx) signal, the RFID reader comprising an RFID reader controller which sets an RF Tx power of the RF Tx signal to a Tx power of the RF Tx signal, wherein the RF Tx power is selected by an external device and used to read the tag information from the RFID tag.

27. A radio frequency identification (RFID) reader which reads tag information from an RFID tag by transmitting an RF transmission (Tx) signal, wherein the RFID reader sets an RF Tx power of the RF Tx signal to a Tx power of the RF Tx signal, wherein the RF Tx power is selected by an external device and used to read the tag information from the RFID tag.
